(19) United States
(12) Patent Application Publication
(10) Pub. No.: US 2007/0299931 A1
(43) Pub. Date: Dec. 27, 2007

(54) Aggregate storage space allocation

(75) Inventor: Brian K. Furphy, Lakeside, CA (US)

Correspondence Address: PETER M. ULLMAN LLC, PO BOX 6764, LAWRENCEVILLE, NJ, 08648-0764, US

(73) Assignee: Futurelabs, Inc. d/b/a HostLabs, San Diego, CA (US)

(21) Appl. No.: 11/474,694

(22) Filed: Jun. 26, 2006

(51) Int. Cl. G06F 15/16

(52) U.S. Cl. 709/217

(57) ABSTRACT

Storage space is pooled for usage across a plurality of web services. A customer enters into an arrangement to purchase a plurality of web services from a web service provider, and also purchases an aggregate allocation of storage space for storing data relating to the customer's use of those services. Additional data can be stored while the customer's aggregate usage across the services does not exceed the limit. A program enforces the aggregate limit across services. If the customer meets, exceeds, or approaches the limit, various actions can be taken, such as charging the customer for more storage space, preventing the storage of new data, denying service, or moving data to an archive. The customer may be alerted or notified about these actions by mechanisms such as E-mail, page, fax, or telephone.

### BACKGROUND

A customer can purchase services that are to be provided by a server that is accessible through a network. Examples of services that can be provided in this manner are web hosting, E-mail hosting, and ColdFusion hosting. Normally, a certain amount of data storage space is used to store data relating to the customer's use of the service—e.g., in the case of web hosting, static web pages and program to generate dynamic web page content are stored; in the case of E-mail hosting, E-mail messages are stored. It is common for the service provider to charge the customer for the storage space based on the amount used for a particular service. In a typical arrangement, the customer pays for a certain amount of storage space (e.g., 100 Mb), and is allowed to use up to that amount of storage space without additional charge.

Conventionally, the customer pays for a storage allocation for each service. That is, if the customer has purchased or subscribed to two services (e.g., web hosting and E-mail hosting), the customer buys an allocation to be used with the web hosting service, and another allocation to be used with the E-mail hosting service. If the customer has excess capacity in the allocation for web hosting but receives enough E-mail to exceed the allocation for E-mail hosting, then the excess web hosting allocation will go to waste, while the customer is either charged for extra E-mail storage capacity or experiences a denial of E-mail service. This situation may occur even if the web hosting and the E-mail hosting are provided by the same service provider. In some circumstances, the inability to pool storage allocations is due to the fact that separate storage devices are used to store data relating to the different services, and there is no mechanism in place to determine the aggregate amount of data stored for a particular customer across these different storage devices.

Systems exist in which various types of resources (e.g., system memory within a computer, processor time in a server farm, etc.) can be shared. Additionally systems exist in which disk space can be purchased to host several web sites. However, customers have not been able to obtain a single allocation of disk space to pool across heterogeneous web services, since enabling this type of pooling presents technological challenges—e.g., the fact that the data used in relation to the different web services is stored on different physical systems, which do not inherently have the ability to recognize that the storage space consumed on two different systems for two different services are chargeable against a common pool of space that has been purchased by a particular customer.

### SUMMARY

An allocation of storage space is pooled, so that the storage space purchased by a customer can be apportioned as-need among several services. A customer, who has purchased two or more services, also purchases an allocation of disk space to be used with the services. A computer program tracks the usage of disk space across the services to determine whether the customer is exceeding the aggregate limit. The computer program can determine the customer's aggregate usage of disk space even when each of the services is implemented on a different machine and stores its data on a different physical storage device. When the aggregate amount of data stored for the customer exceeds the customer's allocation, the program can cause the customer to be charged for additional storage space.

As one example, the subject matter described herein provides a method of providing storage space to a customer that comprises: operating a first server that provides, through a network, a first service; operating a second server that provides, through the network, a second service different from the first service, there being one or more first storage devices that provide storage usable with the first service but not with the second service, there being one or more second storage devices that provide storage usable with the second service but not with the first service; entering into an arrangement with the customer to do the following: to provide the first service using the network; to provides the second service using the network; and to make available to the customer a specified amount of storage space that is usable with a plurality of services comprising the first service and the second service, wherein a price that the customer pays for the storage space is based at least in part on how much storage space is to be provided to the customer; and operating a program that fungibly allocates the specified amount of storage space among storage devices comprising: the one or more first storage devices; and the one or more second storage devices.

As another example, the subject matter described herein provides a method of providing a computer-related service to a customer, the method comprising: providing a plurality of services to the customer, the services comprising at least a first service and a second service that is different from the first service, wherein data stored for the customer is stored in a different storage device depending on which of the plurality of services the data relates to; allocating a specified amount of storage space for the customer's aggregate usage in the services; allowing the customer to use storage space as long as an aggregate amount of storage space taken up by data stored for the customer in relation to the services does not exceed the specified amount of storage space; and if the aggregate amount of storage space taken up by data stored for the customer in relation to the services stands in a definable relation to the specified amount of storage space, then performing one or more actions.

Other features are described below.

### BRIEF DESCRIPTION OF THE DRAWINGS

FIG. 1 is a block diagram of various example components that may be used either with, or as part of, the subject matter described herein.

FIG. 2 is a diagram of a first example of actions that may be performed as part of a process according to the subject matter described herein.

FIG. 3 is a diagram of a second example of actions that may be performed as part of a process according to the subject matter described herein.

### DETAILED DESCRIPTION

Customers often purchase different web services (e.g., web hosting service and E-mail hosting service) from a web service provider. It is desirable for the customer to purchase an aggregate amount of storage space that can be allocated among the different services. The mechanisms described herein allow an aggregate storage space allocation to be enforced across a plurality of services.

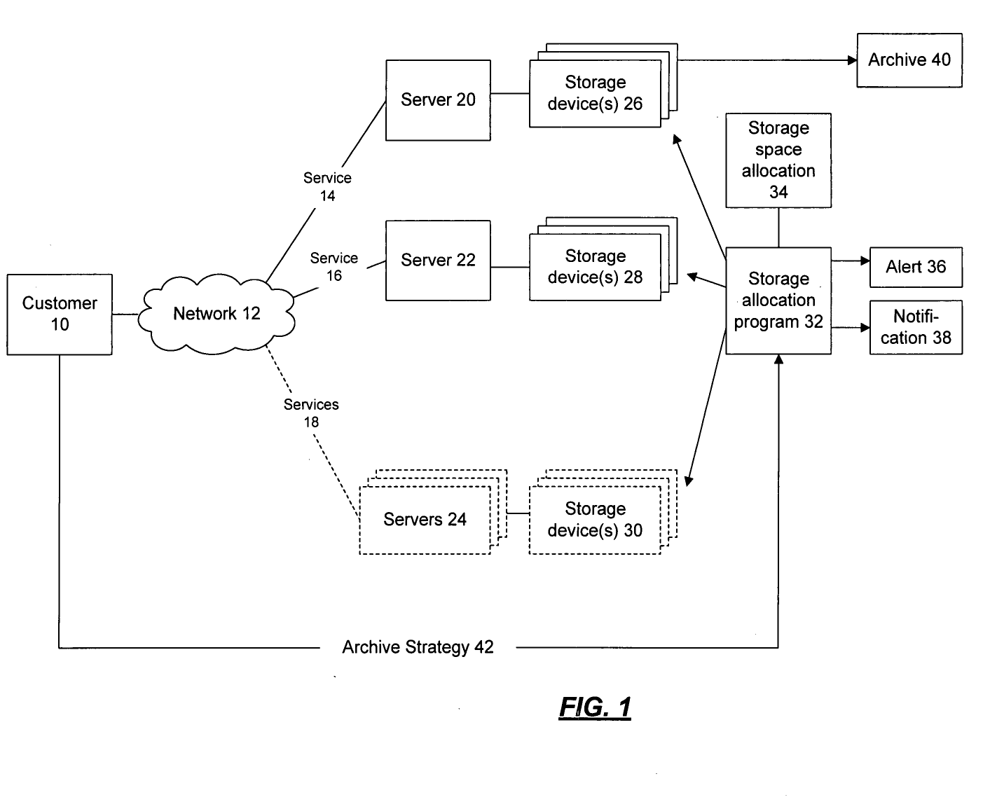

Referring to the drawings, in which like numerals are used to indicate like elements throughout, there is shown in FIG. 1 a diagram of various components that may be used with, or as part of, the subject matter disclosed herein. Customer 10 is an entity (e.g., a person, corporation, etc.) that purchases web services, such as services 14 and 16, from a provider. In order to simplify the description herein, examples are described in which customer 10 obtains two services (i.e., services 14 and 16), although it will be understood that, in general, customer 10 can purchase any number of services. FIG. 1 shows services 18, in addition to services 14 and 16, in order to indicate that any arbitrary number of services can be provided (and that storage space can be pooled across any arbitrary number of services).

Services 14, 16, and 18 are any type of service that can be provided using a network 12. Examples of such services include web hosting services, E-mail hosting services, and ColdFusion hosting services, although this list of example services is not exhaustive. For example, the customer may access (or otherwise use) one or more aspects of a service by communicating with a server through network 12. Typically, the services purchased by customer 10 are different from each other—e.g., service 14 may be a web hosting service, and service 16 is something other than a web hosting service (e.g., service 16 could be an E-mail hosting service).

Each service may be provided by its own server (or collection of servers). In the example shown, service 14 is provided by server 20, service 16 is provided by server 22, and each of services 18 is provided by a corresponding one of servers 24. It should be noted that different services can be hosted on the same machine, although in a large-scale operation each service would typically be hosted on its own machine or group of machines.

Each of servers 20, 22, and 24 is associated with one or more storage devices. In the example shown, server 20 is associated with one or more storage devices 26; server 22 is associated with one or more storage devices 28; and servers 24 are each associated with one or more storage devices 30. The storage device(s) associated with a particular server store data associated with the service that particular server provides. For example, if service 14 is a web hosting service that is provided by server 20, then storage device(s) 26 may store the actual web pages (or code to produce dynamic web pages) that implement web sites hosted on server 20. As another example, if service 16 is an E-mail hosting service that is provided by server 22, then storage device(s) 28 may store incoming and/or outgoing E-mail messages. Typically, the storage device(s) associated with a server (or collection of servers) provides storage for one particular service. For example, if service 14 (hosted on server 20) is a web hosting service and service 16 (hosted on server 22) is an E-mail hosting service, then typically storage device(s) 26 would store web pages (and page-generation code) for the web hosting service and storage device(s) 28 would store E-mail messages, and these two services would not use each other's storage devices. It is physically possible for different services to store their data on a common storage device or a common collection of devices, although such an arrangement is not the norm in a large-scale hosting operation.

Customer 10 enters into an arrangement with a provider of services 14, 16, and 18, whereby the provider will provide services for customer 10, and will also provide some amount of storage space to be used with the services. An “arrangement” may be a formal contract, informal agreement, subscription, or any other type of relationship whereby the customer agrees to obtain services from the provider. Storage space allocation 34 represents the amount of storage space that customer 10 has obtained as part of the arrangement. Storage space allocation may be a fixed quantity of storage space (e.g., 100 Mb), or else may be a variable amount expressed in some defined way (e.g., 10 Mb per E-mail account). It should be noted that the amount of storage space allocation 34 is a specified amount of storage, regardless of whether storage space allocation 34 is a constant amount, or some variable amount based on a formula or rule.

Storage allocation program 32 is a computer program that enforces storage space allocation 34 by determining whether the space taken up by data relating to customer 10's collective use of services (e.g., services 14, 16, and 18) is within the usage limit represented by storage space allocation 34. For example, suppose customer 10 has purchased services 14 and 16 (a web hosting service and E-mail hosting service, respectively), and has purchased 100 Mb to use with those services. If server 26 stores 50 Mb of web pages for customer 10, and server 28 stores 25 Mb of customer 10's E-mails, then storage allocation program 32 should find that customer 10 is using 75 Mb of the 100 Mb allocation, and is within the limit represented by that allocation. On the other hand, if 50 Mb of web pages and 50 Mb of E-mails were being stored (totaling 100 Mb), then storage allocation program 32 should find that the limit represented by storage space allocation 34 has been reached. In effect, the entire amount of storage space represented by storage space allocation 34 is pooled across different services, and the space is thereby treated as a fungible resource; enforcing the allocation across different services can therefore be viewed as fungibly allocating the storage space in the pool.

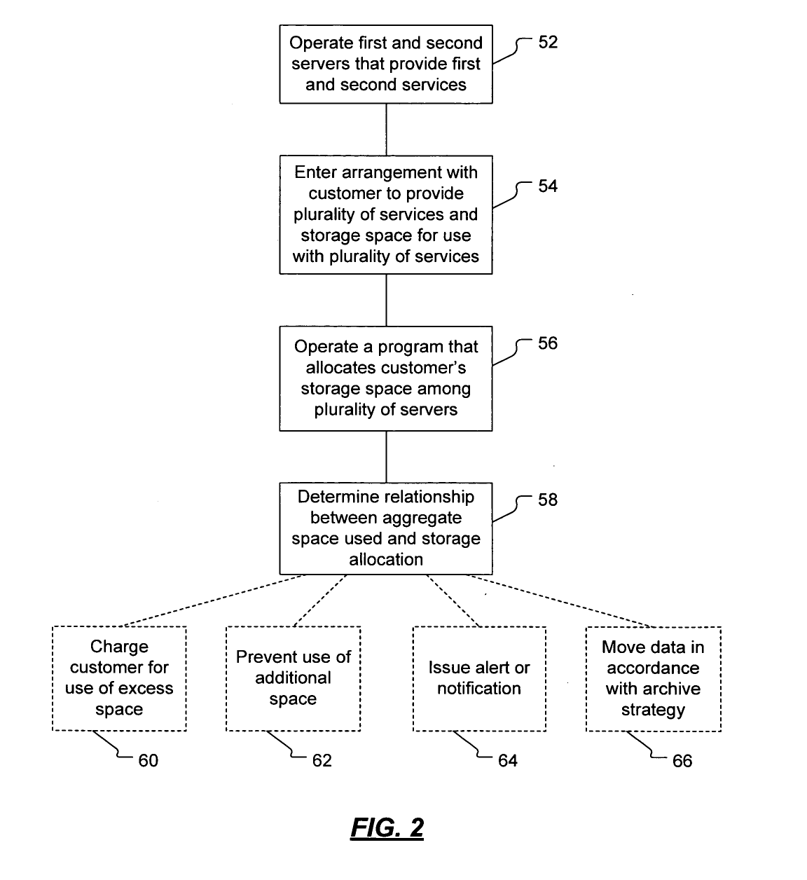

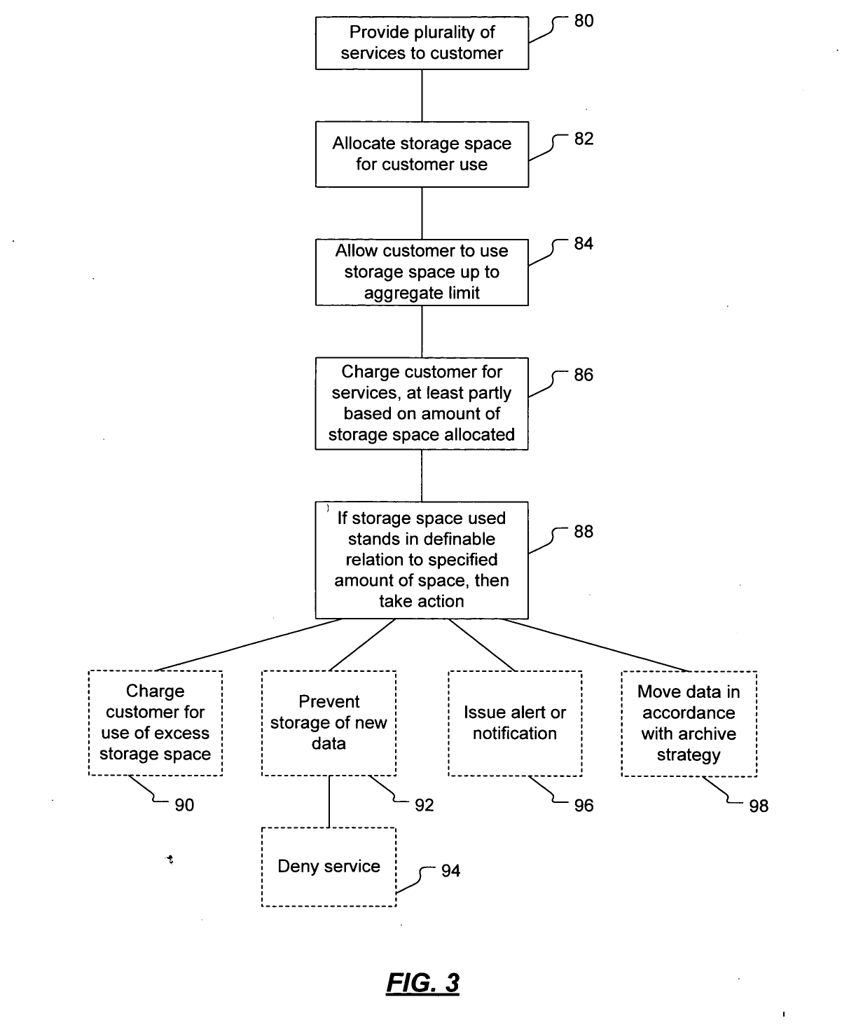

Storage allocation program 32 may take (or cause to be taken) a variety of actions based on whether the limit represented by storage space allocation 34 has been reached, or if usage is approaching the limit. For example, if the customer is almost at the limit, then storage allocation program 32 may issue an alert 36 to customer 10 indicating that the limit is approaching and that the customer should purchase more storage space. Another alternative is that storage allocation program 32 may simply increase storage space allocation 34, arrange to charge customer 10 for additional storage space, and then issue a notification 38 to customer 10 indicating that customer 10's storage space allocation 34 has been increased. A further example of an action that may be taken is that that some or all of the customer's data may be moved to an archive 40 in accordance with an archive strategy 42. The use of an archive is more particularly discussed below. Additionally, the discussion of FIGS. 2 and 3 below lists other examples of actions that can be taken when storage allocation program 34 determines that the limit represented by customer 10's storage space allocation 34 is approaching or has been.

It should be noted that storage allocation program 32 is not limited to determining whether a storage limit is approaching, or has been met or exceeded. In general, storage allocation program 32 can compare the aggregate amount of space used by customer 10 with the limit represented by storage space allocation 34, and then take some action depending on whether the actual usage stands in some definable relation to the limit. For the aggregate usage to equal the limit, exceed the limit, fall short of the limit, or be within n megabytes of the limit are all examples of a definable relation between the actual usage and the limit, although these examples are not exhaustive.

As noted above, one action that can be taken when the storage space allocation 34 is approached or exceeded is to move the customer's data to an archive 40 in accordance with an archive strategy 42. Archive 40 provides long-term storage for data retention, and is preferably (but not necessarily) searchable. Data that is associated with one or more of the services 14, 16, and 18 (and that is stored on one or more of the storage devices 26, 28, and 30) may be moved to archive 40. For simplicity, FIG. 1 shows data being moved to archive 40 from storage device(s) 26, although it will be understood that data to be moved to archive 40 can come from any storage device (e.g., storage device(s) 28 and 30). The data to be moved to the archive may be selected in accordance with an archive strategy 42, which may be provided by customer 10 and received by the program that moves data to archive 40. In general, an archive strategy specifies, in some manner, the data that can be moved to an archive and/or the order in which various kinds of data are to be moved. (E.g., archive the oldest E-mail messages in 10 Mb groups until sufficient space is freed is an example of an archive strategy.)

Referring now to FIGS. 2 and 3, there are shown example actions that can be performed as part of a process according to the subject matter described herein. It should be noted that the actions shown in FIGS. 2 and 3 are not limited to being performed in any particular order. Moreover, FIGS. 2 and 3 include optional actions, and thus the actions shown can be performed in any combination or subcombination, and in any order.

The actions shown in FIG. 2 are now described.

Block 52 shows the act of operating first and second servers that provide a first service and a second service, respectively. Examples of services that can be provided by these servers are discussed above. Additionally, as noted above, any number of services can be provided (and storage space can be pooled across any number of such services), although it is convenient to describe the example in which two services are provided.

Block 54 shows that an arrangement is entered between a provider and a customer to provide a plurality of services, and some specified amount of storage space allocated for use with the plurality of services. Typically, the cost of the arrangement is based at least in part on the amount of storage space allocation that has been purchased. (E.g., $X per service, plus $Y per megabyte of storage.)

Block 56 shows that a program is operated that allocates customer space among the plurality of services. Storage allocation program 32 (shown in FIG. 1) is an example of such a program.

Block 58 shows that it is determined whether the allocated amount of storage space and the aggregate amount of space used by the customer for services stand in some definable relation to each other. This determination may be made by storage allocation program 32. As noted above, the relationship between the storage allocation and the actual usage that program 32 looks for may be any relationship—e.g., that the actual usage is equal to the allocation, that it is with 10 Mb of the allocation, that it exceeds the allocation, etc.

Blocks 60-66 are examples of actions that can be taken when the relationship between the customer's storage allocation and the customer's actual usage are found to meet the definable relationship.

Block 60 shows that the customer can be charged for the use of excess space. For example, if block 58 determines that the customer's storage space allocation has been exceeded, then it may be appropriate to provide the customer with additional space, but to then charge the customer for that space. In a preferred embodiment, the customer is provided with extra space when needed (but then charged for that space, if appropriate), in order to avoid creating a denial of service.

Block 62 (which could be provided as an alternative to block 60) shows that the storing of additional data for use with the customer's services may be prevented. For example, if the customer has exceeded the storage allocation and there is some reason that the customer should not be provided with additional space, then the storage of new data relating to the customer's use of services may be blocked (and a denial of service may result).

Block 64 shows that, as a result of comparing actual usage with the storage allocation, a notification or alert may be issued. For example, if the customer's usage is within 10 Mb of the limit, the customer may receive an alert advising the customer to purchase a larger allocation. Or, if the customer has exceeded the allocation, the customer may receive a notification that the allocation is exceeded and that the customer will be charged for more disk space. The alert or notification can take any appropriate form that communicates information to the customer—for example, an E-mail, a page, a fax, or a telephone call. Any of these forms of communication could be carried out by a computer program (e.g., storage allocation program 32 shown in FIG. 1 could send a pre-defined message by E-mail, page, or fax, or could telephone the customer and recite a recorded message). The alert or notification can also be made by any other mechanism (e.g., a human operator could send an E-mail, or page, or fax, or make a telephone call).

Block 66 shows that data may be moved to an archive—e.g., as a result of a determination that the storage space allocation is either being approached or has been exceeded. As noted above, data may be moved from one of the storage devices associated with a server into an archive in accordance with an archive strategy.

The actions shown in FIG. 3 are now described.

Block 80 shows that a plurality of services are provided to a customer—e.g., as a result of the customer's purchase of services from a service provider.

Block 82 shows that storage space is allocated for the customer's use in relation to the services—e.g., the customer may be allocated an aggregate 100 Mb to be used for a web hosting service and an E-mail hosting service.

Block 84 shows that the customer is allowed to use storage space up to the aggregate limit represented by the storage space allocation.

Block 86 shows that the customer is charged for the provision of services based, at least in part, on the amount of storage space allocated for use with those services.

Block 88 shows that a determination is made as to whether the amount of storage space actually used stands in a definable relation to the amount of storage space specified in the customer's allocation. As noted above, the definable relationship can include, for example, the actual usage equaling the allocation, exceeding it, falling short of it, or being within, say, 10 Mb of the allocation.

Blocks 90-98 show actions that can be taken when the relationship between the customer's storage allocation and the customer's actual usage are found to meet the definable relationship.

Block 90 shows that the customer can be charged for excess storage space—e.g., when the customer's actual usage is found to exceed the existing allocation. It is often preferable that the customer have continuous use of services, and simply be charged for excess storage space when the allocation is needed (as opposed to preventing the storage of new data, as in block 92).

Block 92 (which could be provided as an alternative to block 90) shows that the storage of additional data can be prevented when the customer exceeds the allocation. Preventing the storage of additional data may result in a denial of service (block 94).

Block 96 shows that a notification or alert may be issued. The nature of such a notification or alert, and the circumstances under which such a notification or alert may be issued, are more particularly discussed above—especially in connection with block 64.

Block 98 shows that data may be moved in accordance with an archive strategy—e.g., data may be moved from a particular server's storage device into an archive.

It is noted that the foregoing examples have been provided merely for the purpose of explanation and are in no way to be construed as limiting of the present invention. While the invention has been described with reference to various embodiments, it is understood that the words which have been used herein are words of description and illustration, rather than words of limitations. Further, although the invention has been described herein with reference to particular means, materials and embodiments, the invention is not intended to be limited to the particulars disclosed herein; rather, the invention extends to all functionally equivalent structures, methods and uses, such as are within the scope of the appended claims. Those skilled in the art, having the benefit of the teachings of this specification, may effect numerous modifications thereto and changes may be made without departing from the scope and spirit of the invention in its aspects.

What is claimed:

1. A method of providing storage space to a customer, the method comprising:
operating a first server that provides, through a network, a first service;
operating a second server that provides, through said network, a second service different from said first service, there being one or more first storage devices that provide storage usable with said first service but not with said second service, there being one or more second storage devices that provide storage usable with said second service but not with said first service;
entering into an arrangement with the customer to do the following:
to provide said first service using said network;
to provides said second service using said network; and
to make available to said customer a specified amount of storage space that is usable with a plurality of services comprising said first service and said second service, wherein a price that the customer pays for said storage space is based at least in part on how much storage space is to be provided to the customer; and
operating a program that fungibly allocates said specified amount of storage space among storage devices comprising:
said one or more first storage devices; and
said one or more second storage devices.

2. The method of claim 1, further comprising:
determining that the aggregate amount of storage space used by the customer on said storage devices exceeds said specified amount of storage space;
allowing said customer to use an amount of storage space on said storage devices that, in the aggregate, exceeds said specified amount of storage space;
charging the customer for use of storage space in excess of said specified amount of storage space.

3. The method of claim 1, further comprising:
determining that the aggregate amount of storage space used by the customer on said storage devices exceeds said specified amount of storage space;
in response to said determining, preventing storage of additional data on the storage devices for said customer.

4. The method of claim 1, further comprising:
determining that the aggregate amount of storage space used by the customer on said storage devices stands in a definable relation to said specified amount of storage space; and
in response to said determining, issuing an alert to the customer.

5. The method of claim 4, wherein said alert is in a form that is selected from the group consisting of: an E-mail, a page, a fax, and a telephone call.

6. The method of claim 1, further comprising:
determining that the aggregate amount of storage space used by the customer on said storage devices stands in a definable relation to said specified amount of storage space; and
in response to said determining, issuing a notification to the customer indicating that the customer will be charged for additional storage space, or requesting that the customer purchase additional storage space.

7. The method of claim 1, further comprising:
receiving a specification for an archive strategy;
in response to a determination that the aggregate amount of storage space used by the customer on said storage devices stands in a definable relation to said specified amount of storage space, moving the customer's data that is stored in said storage devices to an archive in accordance with said archive strategy.

8. The method of claim 1, wherein said first service is the hosting of a web site, and wherein said second service is E-mail hosting.

9. The method of claim 1, wherein said first service is the hosting of a web site, and wherein said second service is something other than hosting a web site.

10. A method of providing a computer-related service to a customer, the method comprising:
providing a plurality of services to the customer, the services comprising at least a first service and a second service that is different from said first service, wherein data stored for the customer is stored in a different storage device depending on which of the plurality of services the data relates to;
allocating a specified amount of storage space for the customer's aggregate usage in said services;
allowing the customer to use storage space as long as an aggregate amount of storage space taken up by data stored for the customer in relation to said services does not exceed said specified amount of storage space; and
if the aggregate amount of storage space taken up by data stored for the customer in relation to said services stands in a definable relation to said specified amount of storage space, then performing one or more actions.

11. The method of claim 10, wherein said definable relation is that the amount of storage space taken up by data stored for the customer exceeds said specified amount of storage space, and wherein said one or more actions comprise:
charging the customer for the use of storage space in excess of said specified amount of storage space.

12. The method of claim 10, wherein said definable relation is that the amount of storage space taken up by data stored for the customer exceeds said specified amount of storage space, and wherein said one more actions comprise:
preventing the storage of new data for the customer.

13. The method of claim 12, wherein said preventing the storage of new data for the customer results in a denial of usage of at least one of said services.

14. The method of claim 10, wherein said one or more actions comprise:
issuing an alert to the customer.

15. The method of claim 14, wherein said alert is in a form that is selected from the group consisting of: an E-mail, a page, a fax, and a telephone call.

16. The method of claim 10, wherein said one or more actions comprise:
issuing a notification to the customer that the customer will be charged for additional storage space, or requesting that the customer purchase additional storage space.

17. The method of claim 10, further comprising:
charging, the customer a price for the provision of said services that is at least partly based on said specified amount of storage space.

18. The method of claim 10, wherein said one or more actions comprise:
moving the customer's data to an archive in accordance with an archive strategy provided by the customer.

19. The method of claim 10, wherein said first service is the hosting of a web site, and wherein said second service is E-mail hosting.

20. The method of claim 10, wherein said first service is the hosting of a web site, and wherein said second service is something other than hosting a web site.
